(19) United States
(12) Patent Application Publication
(10) Pub. No.: US 2015/0185599 A1
(43) Pub. Date: Jul. 2, 2015

(54) AUDIO BASED ON CAPTURED IMAGE DATA OF VISUAL CONTENT

(71) Applicant: Brian Mullins, Sierra Madre, CA (US)

(72) Inventor: Brian Mullins, Sierra Madre, CA (US)

(21) Appl. No.: 14/145,338

(22) Filed: Dec. 31, 2013

(51) Int. Cl. G03B 31/06; H04N 5/93

(52) U.S. Cl. CPC G03B 31/06; H04N 5/93

(57) ABSTRACT

Techniques of providing audio based on visual content are disclosed. In some embodiments, image data of visual content is received. The image data has been captured by a computing device. Audio data is determined based on the received image data, and the corresponding audio of the audio data is then caused to be played on the computing device. Determining the audio data may comprise identifying the received image data based on one or more characteristics of the received image data, and determining the audio data based on the identification of the received image data. The received image data can comprise video or still pictures. The audio of the audio data can comprise a song or a voice recording. The user computing device can comprises one of a smart phone, a tablet computer, a wearable computing device, a vehicle computing device, a laptop computer, and a desktop computer.

### TECHNICAL FIELD

The present application relates generally to the technical field of data processing, and, in various embodiments, to methods and systems of providing audio based on captured image data of visual content.

### BACKGROUND

Current electronic devices, such as digital media players, enable users to listen to audio content, such as music. However, the audio content being played on these electronic devices lacks any connection with the real-world environment and situations in which the electronic devices are being used.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 is a block diagram illustrating an audio determination system, in accordance with some embodiments;

FIGS. 2A-2E illustrate examples embodiments of the audio determination system being used to provide audio based on captured imaged data of visual content;

FIG. 3 is a flowchart illustrating a method of providing audio based on captured image data of visual content, in accordance with some embodiments;

FIG. 4 is a flowchart illustrating a method of determining audio data based on received image data, in accordance with some embodiments;

FIG. 5 illustrates a mapping of image identifiers to audio files, in accordance with some embodiments;

FIG. 6 is a flowchart illustrating another method of determining audio data based on received image data, in accordance with some embodiments;

FIG. 7 is a flowchart illustrating a method of managing audio files and image data identifiers for providing audio based on captured image data of visual content, in accordance with some embodiments;

FIG. 8 is a block diagram of an example computer system on which methodologies described herein may be executed, in accordance with some embodiments; and

FIG. 9 is a block diagram illustrating a mobile device, in accordance with some embodiments.

### DETAILED DESCRIPTION

Example methods and systems of providing audio based on captured image data of visual content are disclosed. In the following description, for purposes of explanation, numerous specific details are set forth in order to provide a thorough understanding of example embodiments. It will be evident, however, to one skilled in the art that the present embodiments may be practiced without these specific details.

As will be disclosed herein, an audio determination system may be configured to provide audio, such as songs and voice recordings, to a computing device based on image data of visual content captured by the computing device. The audio determination system may enable the user of the computing device, or other users of other computing devices, to arrange for certain audio to be played when the computing device captures certain image data. This technology opens the door to a variety of possibilities for presenting a user with audio that is tailored for what the user is currently experiencing without the user having to take time to actively request audio in the moment. Additionally, providers of products and services (e.g., magazine publishers, museum administrators, etc.) can use the audio determination system to arrange for certain audio to be played to users at certain times when the users are using or experiencing the products and services.

In some embodiments, image data of visual content is received. The image data has been captured by a user computing device. Audio data is then determined based on the received image data. Audio of the audio data is then caused to be played on the user computing device.

In some embodiments, determining the audio data comprises identifying the received image data based on at least one characteristic of the received image data, and determining the audio data based on the identification of the received image data. In some embodiments, identifying the received image data comprises using at least one computer vision technique to analyze the received image data. In some embodiments, the reference image data comprises at least one of images and image identification rules.

In some embodiments, determining the audio data based on the received image data comprises accessing a database of audio files, each audio file registered in association with at least one corresponding image data identifier, retrieving at least one of the audio files based on a correlation between the received image data and the at least one corresponding image identifier of the at least one audio file, and providing the at least one audio file as the audio data to be played on the user computing device. In some embodiments, the at least one registered audio file comprises a playlist of songs. In some embodiments, prior to receiving the image data of visual content, a request to associate the at least one audio file with the at least one corresponding image data identifier is received, and the at least one audio file is associated, in the database of audio files, with the at least one corresponding image data identifier in response to receiving the request. In some embodiments, the request is received from a curator computing device different from the user computing device. In some embodiments, prior to receiving the request to associate, an upload of the at least one audio file is received, and the at least one audio file is registered in the database in response to receiving the upload of the at least one audio file.

In some embodiments, the received image data comprises video or still pictures. In some embodiments, the audio comprises a song or a voice recording. In some embodiments, the user computing device comprises one of a smart phone, a tablet computer, a wearable computing device, a vehicle computing device, a laptop computer, and a desktop computer. In some embodiments, the machine comprises a remote server separate from the user computing device.

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

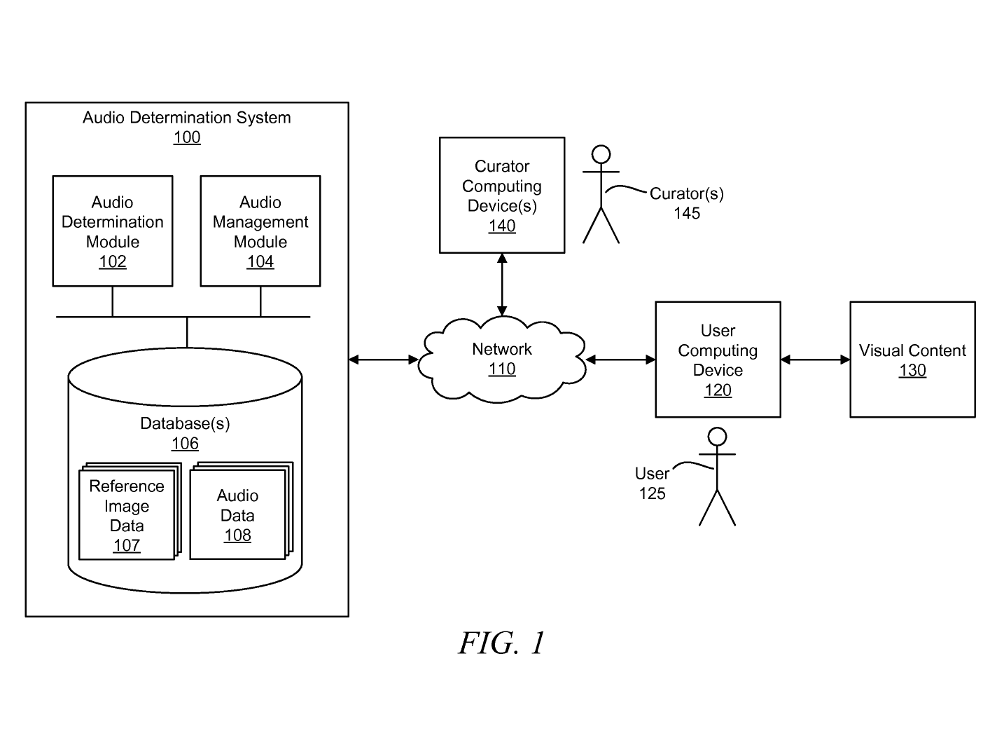

FIG. 1 is a block diagram illustrating an audio determination system 100, in accordance with some embodiments. In some embodiments, audio determination system 100 comprises an audio determination module 102. The audio determination module 102 may be configured to receive captured image data of visual content 130. The visual content 130 may comprise any visual content 130 capable of being captured by a computing device, such as user computing device 120, having image capture functionality. A user 125 may use the user computing device 120 to capture image data of the visual content 130. Examples of a user computing device 120 include, but are not limited to, a smart phone, a tablet computer, a wearable computing device, a vehicle computing device, a laptop computer, and a desktop computer. In some embodiments, the user computing device 120 comprises a built-in camera or camcorder with which the user 125 can capture the image data of the visual content 130. However, it is contemplated that other configurations are also within the scope of the present disclosure.

The audio determination system 100 can comprise one or more databases 106. The database(s) 106 may store audio data 108, which the audio determination module 102 can select based on the image data. The user computing device 120 can provide the image data to the audio determination module 102, which can then determine what audio data 108 to cause to be played on the user computing device 120 based on the image data. In some embodiments, the audio data 108 comprises audio files of songs and/or voice recordings. However, it is contemplated that other types of audio data are also within the scope of the present disclosure.

The audio determination module 102 can cause audio corresponding to the selected audio data 108 to be played on the user computing device 120. The audio data 108 may comprise any representation of the actual audio itself. For example, the audio data 108 may comprise an audio file of the audio (e.g., an MP3 file of a song). Alternatively, the audio data 108 may comprise an identification of an audio file, which can then be used to identify and retrieve the corresponding audio file for presentation as audio on the user computing device 120. Other configurations are also within the scope of the present disclosure.

In some embodiments, the audio determination module 102 is configured to cause the audio to be played on the user computing device 120 for a predetermined amount of time. In some embodiments, the audio determination module 102 is configured to cause the audio to be played on the user computing device 120 until a predetermined condition is met. One example of a predetermined condition is the audio determination module 102 receiving subsequent captured image data from the user computing device 120 and determining the corresponding subsequent audio data 108 for the received image data. In this respect, the audio determination module 102 may cause the user computing device 120 to change the audio that it is playing from a first set of one or more audio files to a second set of one or more audio files in response to the user computing device 120 capturing image data indicating that the current real-world experience warrants a change from the first set of one or more audio files to the second set of one or more audio files. Examples of such audio-changing events include, but are not limited to, the user 125 flipping the page of a magazine from one page (corresponding to one song) to another page (corresponding to another song) while the user computing device 120 captures the event, and the user 125 walking from one location (corresponding to one song) to another location (corresponding to a voice recording). Other audio-changing events are also within the scope of the present disclosure.

In some embodiments, determining the corresponding audio data 108 for received image data comprises augmenting an aspect of an audio file or augmenting the playing of an audio file. For example, in some embodiments, the audio determination module 102 may be configured to increase or decrease the tempo of a song based on a change in the user's real-world experience. The audio determination module 102 may be configured to increase the tempo of a song based on an analysis of received image data that indicates that the user 125, while wearing the user computing device 120, transitioned from a walking pace to a running pace or that the user 120 is viewing scenery or a scene from a movie that is visually getting darker. In this respect, characteristics of the audio may be changed in accordance with a change in the captured image data, as opposed to the audio being changed completely from one audio file to a distinctly different audio file.

In some embodiments, the audio determination module 102 provides the selected audio data 108 to the user computing device 120. Communication of data between the user computing device 120 and components of the audio determination system 120, such as the audio determination module 102, can be achieved via communication over a network 110. Accordingly, the audio determination system 100 can be part of a network-based system. For example, the audio determination system 100 can be part of a cloud-based server system. However, it is contemplated that other configurations are also within the scope of the present disclosure. The network 110 may be any network that enables communication between or among machines, databases, and devices. Accordingly, the network 110 may be a wired network, a wireless network (e.g., a mobile or cellular network), or any suitable combination thereof. The network 110 may include one or more portions that constitute a private network, a public network (e.g., the Internet), or any suitable combination thereof.

In some embodiments, the audio determination system 100 can reside on a remote server that is separate and distinct from the user computing device 120. In some embodiments, the audio determination system 100 can be integrated into the user computing device 120. In some embodiments, certain components (e.g., database 106) of the audio determination system 100 can reside on a remote server that is separate and distinct from the user computing device 120, while other components (e.g., audio determination module 102) of the audio determination system 100 can be integrated into the user computing device 120. Other configurations are also within the scope of the present disclosure.

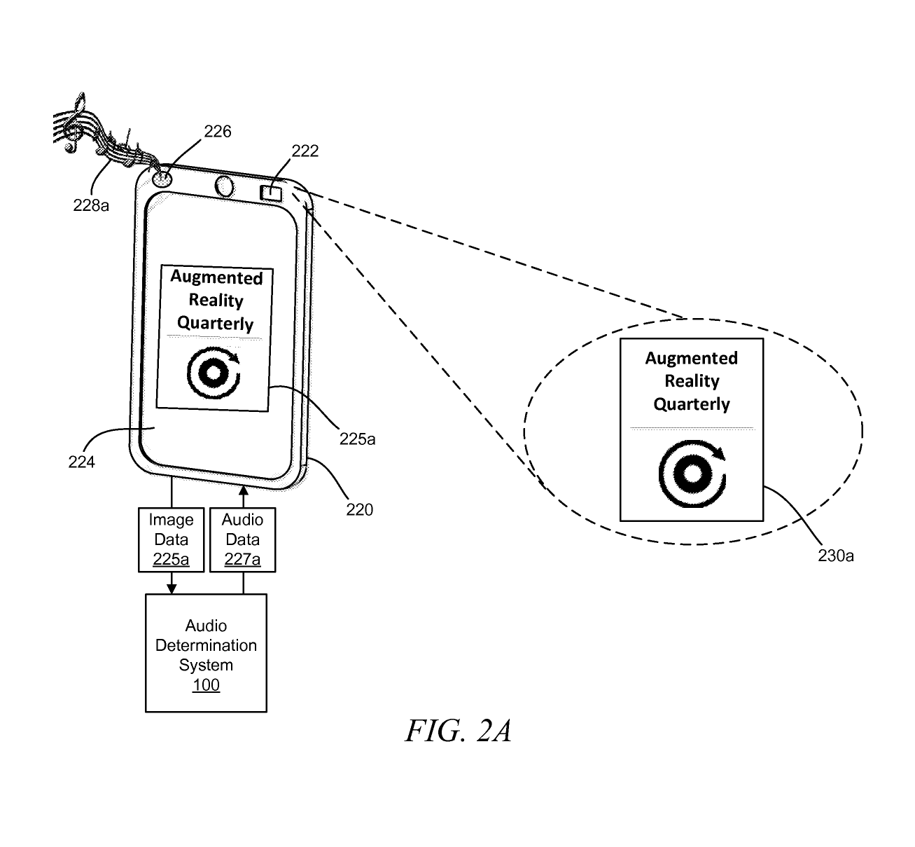

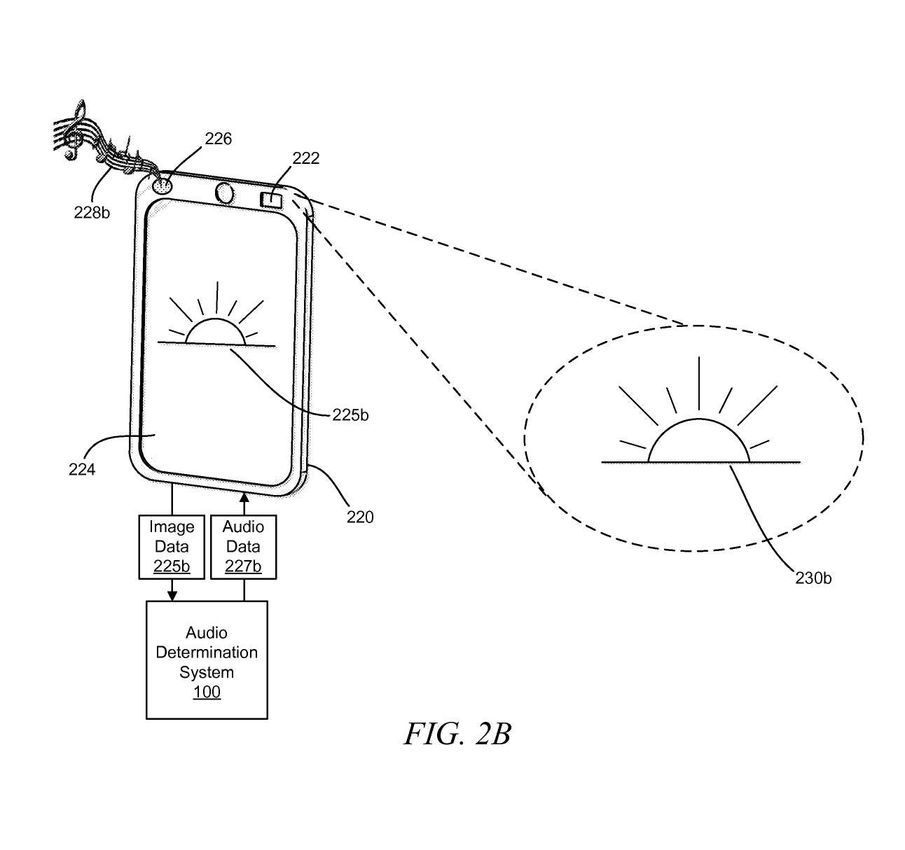

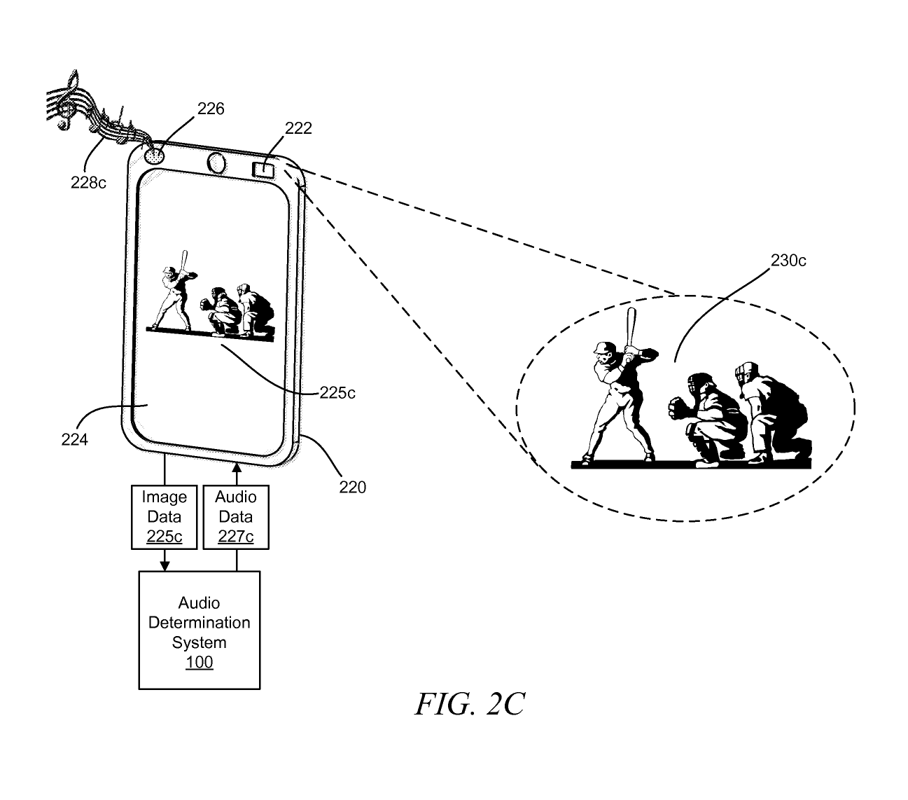

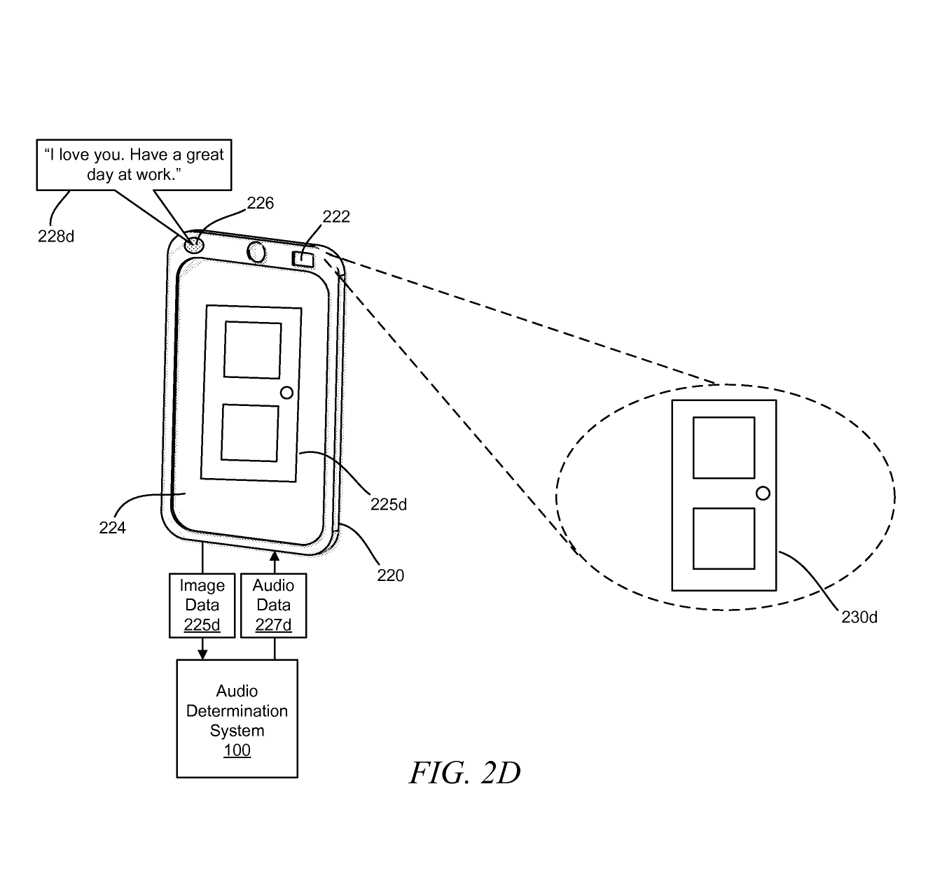

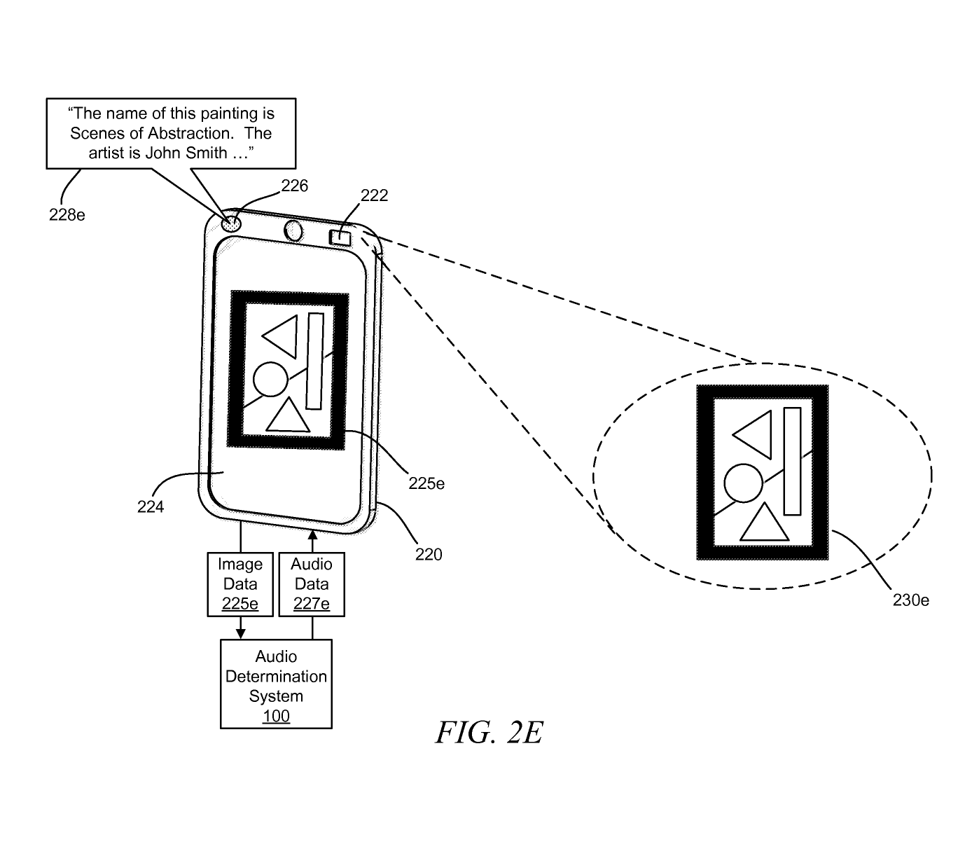

FIGS. 2A-2E illustrate examples embodiments of the audio determination system 100 being used to provide audio based on captured image data of visual content. In each of the example embodiments of FIGS. 2A-2E, a user computing device 220 is being used. User computing device 220 may have all of the features and functionality of user computing device 120 discussed herein. In some embodiments, the user computing device 220 comprises an image capture device 222, such as a built-in camera or camcorder, configured to capture image data of visual content. The user computing device 220 may also comprise a display screen 224. The display screen 224 may comprise a touchscreen configured to receive a user input via a contact on the touchscreen. Although, other types of display screens 224 are also within the scope of the present disclosure. In some embodiments, the display screen 224 is configured to display the captured image data. In some embodiments, the display screen 224 is transparent or semi-opaque so that the user 125 can see through the display screen 224. The user computing device 220 may also comprise an audio output device 226, such as a built-in speaker, through which audio can be output.

In the example of FIG. 2A, a user 125 may be reading a magazine 230a (e.g., “Augmented Reality Quarterly”), which can constitute visual content upon which a determination of audio can be based. The image capture device 222 can be used to capture image data 225a of the magazine 230a. The captured image data 225a can be displayed on the display screen 224. However, in some embodiments, the captured image data 225a is not displayed on the display screen 224 in order to avoid obstructing the user's view. The captured image data 225a may be an image of the cover of the magazine 230a, one of the pages within the cover of the magazine 230a, or a portion of either. The user computing device 220 can provide the image data 225a to the audio determination system 100, which can determine audio data 227a based on the image data 225a. The audio determination system 100 can provide the determined audio data 227a to the user computing device 220, where the corresponding audio 228a can be played via the audio output device 226.

In some embodiments, a mapping of image data 225a to audio data 227a can be configured by the publisher of the magazine 230a, or some other curator, in order to dictate an audio experience for the user 125. For example, the publisher may want certain music to be played on the user computing device 220 as the user 125 is reading the magazine 230a with the user computing device 220. The publisher may arrange for certain songs to be mapped to the recognition of certain pages, so that the user 125 hears the songs that the publisher wants the user 125 to hear when the publisher wants the user 125 to hear them. For example, the publisher may arrange for Song A to be played on the user computing device 220 upon recognition by the audio determination system 100 of the captured image data 225a as the cover of the magazine, Song B to be played on the user computing device 220 upon recognition by the audio determination system 100 of the captured image data 225a as the table of contents in the magazine 230a, Song C to be played on the user computing device 220 upon recognition by the audio determination system 100 of the captured image data 225a as corresponding to a particular article within the magazine 230a, and so on and so forth.

In the example of FIG. 2B, a user 125 may be watching a sunset 230b, which can constitute visual content upon which a determination of audio can be based. The image capture device 222 can be used to capture image data 225b of the sunset 230b. The captured image data 225b can be displayed on the display screen 224. However, in some embodiments, the captured image data 225b is not displayed on the display screen 224 in order to avoid obstructing the user's view. The captured image data 225b may be an image of the sunset, or a portion thereof. The user computing device 220 can provide the image data 225b to the audio determination system 100, which can determine audio data 227b based on the image data 225b. The audio determination system 100 can provide the determined audio data 227b to the user computing device 220, where the corresponding audio 228a can be played via the audio output device 226.

In some embodiments, a mapping of image data 225b to audio data 227b can be configured by the user 125, or some other curator. For example, the user 125 may arrange for a playlist of songs to be played on the user computing device 220 when the user 125 is viewing a sunset (e.g., sunset 230b) using the user computing device 220. Accordingly, the user 125 may arrange for certain songs to be mapped to the recognition of a sunset, so that the user 125 hears those songs during that real-world experience.

In the example of FIG. 2C, a user 125 may be watching a baseball game 230c, which can constitute visual content upon which a determination of audio can be based. The image capture device 222 can be used to capture image data 225c of the baseball game 230c. The captured image data 225c can be displayed on the display screen 224. However, in some embodiments, the captured image data 225c is not displayed on the display screen 224 in order to avoid obstructing the user's view. The captured image data 225c may be an image of the baseball game 230c, or a portion thereof. The user computing device 220 can provide the image data 225c to the audio determination system 100, which can determine audio data 227c based on the image data 225c. The audio determination system 100 can provide the determined audio data 227c to the user computing device 220, where the corresponding audio 228c can be played via the audio output device 226.

In some embodiments, a mapping of image data 225c to audio data 227c can be configured by the user 125, or some other curator. For example, the user 125 may arrange for a playlist of songs to be played on the user computing device 220 when the user 125 is viewing a baseball game (e.g., baseball game 230c) using the user computing device 220. Accordingly, the user 125 may arrange for certain songs to be mapped to the recognition of a baseball game, so that the user 125 hears those songs during that real-world experience.

In the example of FIG. 2D, a user 125 may be leaving his house and looking at the front door 230d, which can constitute visual content upon which a determination of audio can be based. The image capture device 222 can be used to capture image data 225d of the front door 230d. The captured image data 225d can be displayed on the display screen 224. However, in some embodiments, the captured image data 225d is not displayed on the display screen 224 in order to avoid obstructing the user's view. The captured image data 225d may be an image of the front door 230d, or a portion thereof. The user computing device 220 can provide the image data 225d to the audio determination system 100, which can determine audio data 227d based on the image data 225d. The audio determination system 100 can provide the determined audio data 227d to the user computing device 220, where the corresponding audio 228d can be played via the audio output device 226.

In some embodiments, a mapping of image data 225d to audio data 227d can be configured by the user 125, or some other curator. For example, a significant other of the user 125 may record a voice message (e.g., “I love you. Have a great day at work.”) to be played on the user computing device 220 when the user 125 is leaving the house. Accordingly, certain voice messages may be mapped to the recognition of the front door 230d of the house, so that the user 125 hears those voice messages during that real-world experience. Other examples of voice messages include, but are not limited to, reminders to run errands upon recognition of the user 125 leaving the house or approaching his or her car, shopping lists upon recognition of the front of a supermarket or a particular section (e.g., aisle) of the supermarket, and so on.

In the example of FIG. 2E, a user 125 may be at an art museum, looking at a particular piece of art work 230e, which can constitute visual content upon which a determination of audio can be based. The image capture device 222 can be used to capture image data 225e of the art work 230e. The captured image data 225e can be displayed on the display screen 224. However, in some embodiments, the captured image data 225e is not displayed on the display screen 224 in order to avoid obstructing the user's view. The captured image data 225e may be an image of the art work 230e, or a portion thereof. The user computing device 220 can provide the image data 225e to the audio determination system 100, which can determine audio data 227e based on the image data 225e. The audio determination system 100 can provide the determined audio data 227e to the user computing device 220, where the corresponding audio 228e can be played via the audio output device 226.

In some embodiments, a mapping of image data 225e to audio data 227e can be configured by an administrator of an art museum that is presenting the art work 230e, or some other curator, in order to dictate an audio experience for the user 125. For example, the administrator may want certain music or voice recordings to be played on the user computing device 220 as the user 125 is viewing certain pieces of art work 230e with the user computing device 220. The administrator may arrange for certain voice recordings to be mapped to the recognition of certain pieces of art work 230e in the art museum, so that the user 125 hears relevant information (e.g., “The name of this painting is Scenes of Abstraction. The artist is John Smith . . . ”) for each corresponding piece of art work 230e that is being viewed by the user 125 via the user computing device 220.

In one other example contemplated, but not shown, the audio determination system 100 can be used to provide an informational warning to a user 125 based on received image data indicating that the user 125 is located in an area where the informational warning is appropriate. For example, the user 125 may enter an industrial factory while wearing the user computing device 120. The user computing device 120 may capture image data of the industrial factory and provide this captured image data to the audio determination module 102, which can then identify the captured image data as corresponding to the industrial factory and determine the corresponding audio data 108 to provide to the user computing device 120, where the corresponding audio (e.g., “The machinery on your right is extremely hot. Proceed with caution.”) can be played via the audio output device 226.

Other scenarios of the audio determination system 100 being used to provide audio based on captured image data of visual content are also within the scope of the present disclosure.

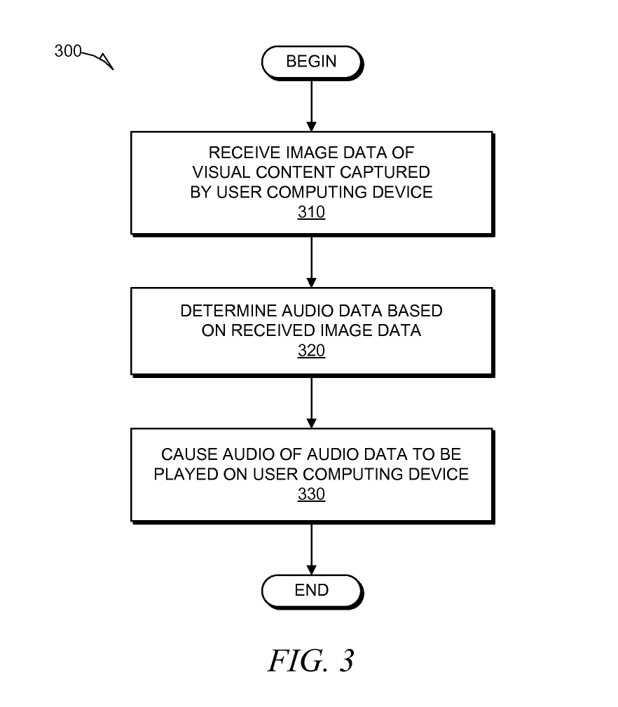

FIG. 3 is a flowchart illustrating a method 300 of providing audio based on captured image data of visual content, in accordance with some embodiments. The operations of method 300 may be performed by a system or modules of a system (e.g., audio determination system 100 or audio determination module 102 in FIG. 1). At operation 310, image data of visual content 130 can be received. The image data may have been captured by a user computing device 120. At operation 320, audio data 108 may be determined based on the received image data. At operation 330, corresponding audio of the audio data 108 may then be caused to be played on the user computing device 120. It is contemplated that the operations of method 300 may incorporate any of the other features disclosed herein.

Referring back to FIG. 1, in some embodiments, the audio determination module 102 can identify the image data based on one or more characteristics of the received image data. In some embodiments, this identification can be based on a comparison of the characteristic(s) of the received image data with reference image data 107, which may be stored in database(s) 106. In some embodiments, the reference image data 107 comprises images. The audio determination module 102 can determine a level of similarity between the received image data and the reference image data 107. If the level of similarity meets a predetermined threshold level of similarity, then the received image data can identified as being of the same content or type of content (e.g., an image of a specific magazine 230a, an image of a sunset 230b, an image of a baseball game 230c, an image of a front door 230d, an image of a piece of art work 230e, etc.) as the reference image data 107. In some embodiments, the audio determination module 102 may access reference image data that is not stored in the database(s) 106, but is rather stored by an external source. For example, the audio determination module 102 can perform a search of the Internet for one or more images that are similar to the received image data in an attempt to identify the received image. Information associated with the search result images, such as metadata, can be used by the audio determination module 102 to identify the received image data.

In some embodiments, the reference image data 107 comprises image identification rules. Image identification rules are rules used identify the received image data based on characteristics of portions of the received image data. For example, image identification rules may indicate that when certain shapes and/or colors are grouped together in a certain configuration that they represent certain content (e.g., objects or scenes). In one example, the reference image data 107 may not comprise actual images of a front door with which to compare the received image data, but rather rules defining what characteristics constitute a front door (e.g., rectangular shape, a handle or knob located about midway up the vertical length, at least two hinges on the side, etc.). In another example, the reference image data 107 may not comprise actual images of a sunset with which to compare the received image data, but rather rules defining what characteristics constitute a sunset (e.g., semi-circular shape, specific colors of light, etc.). Other examples and variations of image identification rules being used as reference image data 107 are also within the scope of the present disclosure.

The audio determination module 102 can determine an identification for the received image data using images and/or image identification rules. Based on the identification of the received image data using the reference image data 107, the audio determination module 102 can determine the appropriate corresponding audio data 108.

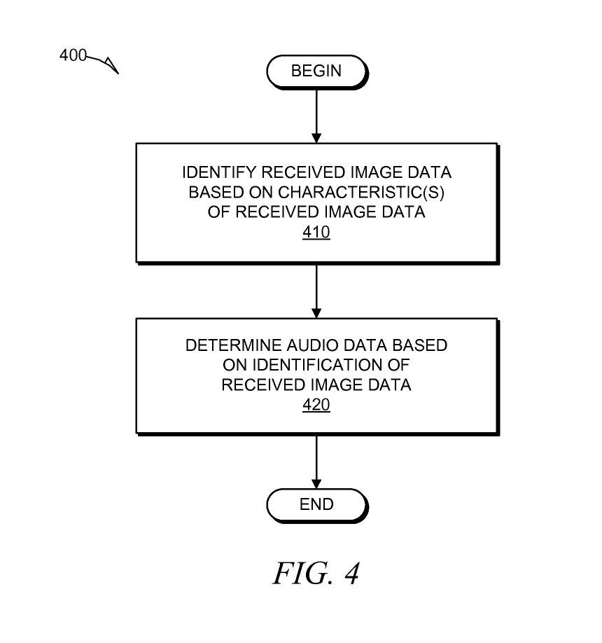

FIG. 4 is a flowchart illustrating a method 400 of determining audio data based on received image data, in accordance with some embodiments. The operations of method 400 may be performed by a system or modules of a system (e.g., audio determination system 100 or audio determination module 102 in FIG. 1). At operation 410, the received image data can be identified based on at least one characteristic of the received image data. In some embodiments, this identification can be based on a comparison of the received image data with reference image data 107, such as by comparing one or more characteristics (e.g., size, dimensions, shape, color, brightness, angles, etc.) of the received image data with one or more characteristics of the reference image data 107. In some embodiments, the received image data can be identified using at least one computer vision technique to analyze the received image data. Computer vision techniques may include processing, analyzing, and understanding image data in order to produce information Examples of computer vision techniques may include, but are not limited to, image recognition, object recognition, and character recognition. At operation 420, audio data 108 may be determined based on the identification of the received image data. It is contemplated that the operations of method 400 may incorporate any of the other features disclosed herein.

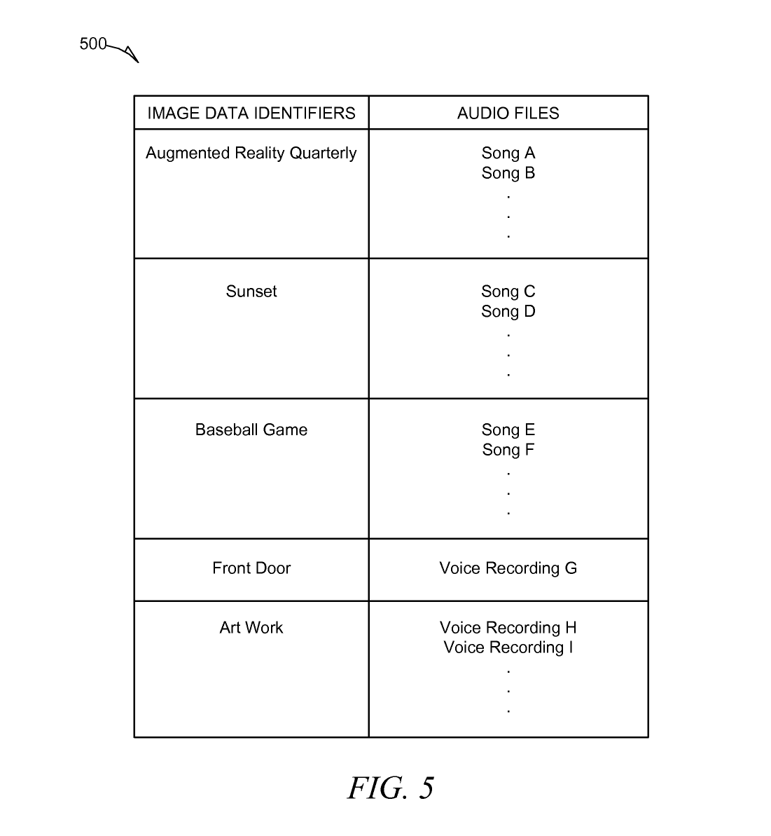

Referring back to FIG. 1, audio data 108 may comprise audio files (e.g., MP3 files) stored in the database(s) 106. Each audio file can be registered in association with at least one corresponding image data identifier. An image data identifier can be any identifier that can be used to identify a specific image (e.g., a specific magazine cover) or a category of images (e.g., sunsets). FIG. 5 illustrates a mapping 500 of image identifiers to audio files, in accordance with some embodiments. This mapping may be used by the audio determination module 102 to determine and retrieve the appropriate audio file(s) for presentation on the user computing device 120. In some embodiments, the audio determination module 102 is configured to retrieve at least one of the audio files based on a correlation between the received image data and the at least one corresponding image identifier of the at least one audio file, and then provide the audio file(s) as the audio data 108 to be played on the user computing device 120. Each image data identifier may have a corresponding song, playlist of songs, voice recording, playlist of voice recordings, or combination thereof. Other types and combinations of audio files are also within the scope of the present disclosure.

In the example shown in FIG. 5, image data identifier “Augmented Reality Quarterly” is associated with a particular playlist of songs (Song A, Song B, . . . ) so that this particular playlist of songs will be retrieved by the audio determination module 102 and caused to be played on the user computing device 120 in response to the audio determination module 102 identifying the received image data as corresponding to the image data identifier “Augmented Reality Quarterly” (e.g., in the scenario of FIG. 2A). Image data identifier “Sunset” is associated with a particular playlist of songs (Song C, Song D, . . . ) so that this particular playlist of songs will be retrieved by the audio determination module 102 and caused to be played on the user computing device 120 in response to the audio determination module 102 identifying the received image data as corresponding to the image data identifier “Sunset” (e.g., in the scenario of FIG. 2B). Image data identifier “Baseball Game” is associated with a particular playlist of songs (Song E, Song F, . . . ) so that this particular playlist of songs will be retrieved by the audio determination module 102 and caused to be played on the user computing device 120 in response to the audio determination module 102 identifying the received image data as corresponding to the image data identifier “Baseball Game” (e.g., in the scenario of FIG. 2C). Image data identifier “Front Door” is associated with a particular voice recording (Voice Recording G) so that this particular voice recording will be retrieved by the audio determination module 102 and caused to be played on the user computing device 120 in response to the audio determination module 102 identifying the received image data as corresponding to the image data identifier “Front Door” (e.g., in the scenario of FIG. 2D). Image data identifier “Art Work” is associated with a particular playlist of voice recordings (Voice Recording H, Voice Recording I, . . . ) so that this particular playlist of voice recordings will be retrieved by the audio determination module 102 and caused to be played on the user computing device 120 in response to the audio determination module 102 identifying the received image data as corresponding to the image data identifier “Art Work” (e.g., in the scenario of FIG. 2E). Other configurations are also within the scope of the present disclosure.

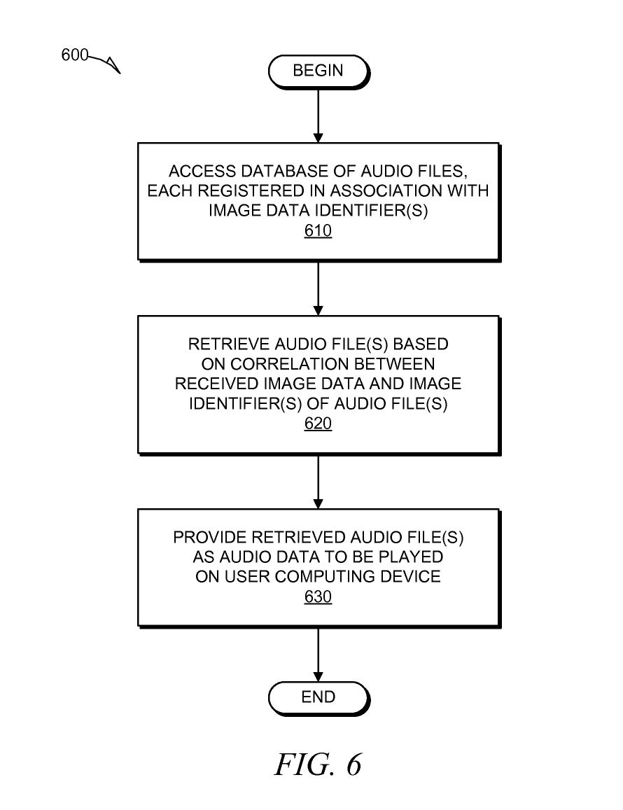

FIG. 6 is a flowchart illustrating another method 600 of determining audio data based on received image data, in accordance with some embodiments. The operations of method 600 may be performed by a system or modules of a system (e.g., audio determination system 100 or audio determination module 102 in FIG. 1). At operation 610, a database 106 of audio files can be accessed. Each audio file can be registered in association with at least one corresponding image data identifier. At operation 620, at least one of the audio files can be retrieved based on a correlation between the received image data and the corresponding image identifier(s) of the audio file(s). At operation 630, the retrieved audio file(s) can be provided as the audio data 108 to the user computing device 120. It is contemplated that the operations of method 300 may incorporate any of the other features disclosed herein.

Referring back to FIG. 1, the audio determination system 100 may comprise an audio management module 104 configured to manage the associations between the reference image data 107, the image data identifiers, and the audio files. In some embodiments, prior to receiving the image data of visual content 130 from the user computing device 120, the audio management module 104 receives a request to associate at least one audio file with at least one corresponding image data identifier. In some embodiments, the audio management module 104 receives an upload of the audio file(s) and registers the uploaded audio file(s) in the database(s) 106. The audio management module 104 may be configured to associate the audio file(s), in the database(s) 106, with the corresponding image data identifier(s) in response to receiving the request. In some embodiments, the requests and/or uploads may be received from a user 125 on the user computing device 125 or on another user computing device. In some embodiments, the requests and/or uploads may be received from one or more curators 145 (different from the user 125) on the user computing device 120 or one or more curator computing devices 140 different from the user computing device 120. The curator(s) 145 may include any people that have an interest in tailoring an audio experience for the user 125 on the user computing device 120 (or any computing device associated with the user 125) for when the user 125 is using and/or experiencing a product, service, and/or situation. Examples of curators 145 may include, but are not limited to, family members, friends, co-workers, product providers, and service providers.

The audio management module 104 may also be configured to receive and implement requests by the user 125 or the curator(s) 145 to assign or otherwise set conditions for the playing and/or termination of the playing of the corresponding audio for specified image data identifiers. For example, the user 125 may request that a song be played for a specified amount of time after the corresponding image data is captured. In one example, an administrator of an art museum may request that audio corresponding to a particular piece of art work stop being played once the audio determination module 102 determines that the user 125 is no longer looking at that particular piece of art work, whether or not the user 125 has started looking at another piece of art work. The user computing device 120 may capture image data indicating this change in the user's attention and provide it to the audio determination module 102, which may then reference the assigned conditions for the audio and determine that the audio should stop playing on the user computing device 120. The audio determination module 102 may then instruct the user computing device 120 accordingly.

Additionally, the audio management module 104 may be configured to receive and implement requests by the user 125 or the curator(s) 145 to have an aspect of an audio file or the playing of an audio file be augmented based on a change in the user's real-world experience that is determined by the audio determination module 102 based on one or more indications provided by image data captured by the user computing device 120 during the change in the user's real-world experience.

It is contemplated that certain associations between image data and audio data may be configured to apply to only a specified user 125, a specified group of users 125, a specified user computing device 120, and/or a specified group of user computing devices 120, while certain other associations between image data and audio data may be configured to apply to all users 125 and/or all user computing devices 120. For example, a user 125 may instruct the association of a particular song to be played on the user computing device 120 when image data of a sunset is captured by the user computing device 120. However, this association of the particular song may not be made for other users 125 when their corresponding user computing devices 120 capture image data of a sunset. Instead, different associations of songs with a sunset may apply to these other users 125 or their other user computing devices 120. Conversely, a magazine publisher may want the same playlist of songs to be played to every user 125 on their corresponding user computing devices 120 when their corresponding user computing devices 120 capture image data of a magazine specified by the magazine publisher, thus providing a consistent audio experience for every user 125 that reads the magazine using their corresponding user computing device 120.

In some embodiments, the audio management module 104 may only allow certain users 125 and/or curators 145 to manage the associations between image data and audio data for a particular person, device, product, or situation. Permission to manage these associations may be dictated by one or more users. In some embodiments, each user 125 and/or user computing device 120 may have a corresponding profile for which permissions and associations are made. When certain management functions are requested, the audio management module 104 may access the appropriate corresponding profile to determine whether the request should be granted. For example, a user 125 may authorize his wife to make certain management decisions for the associations between image data and audio data, but not his children. Other examples and embodiments are also within the scope of the present disclosure.

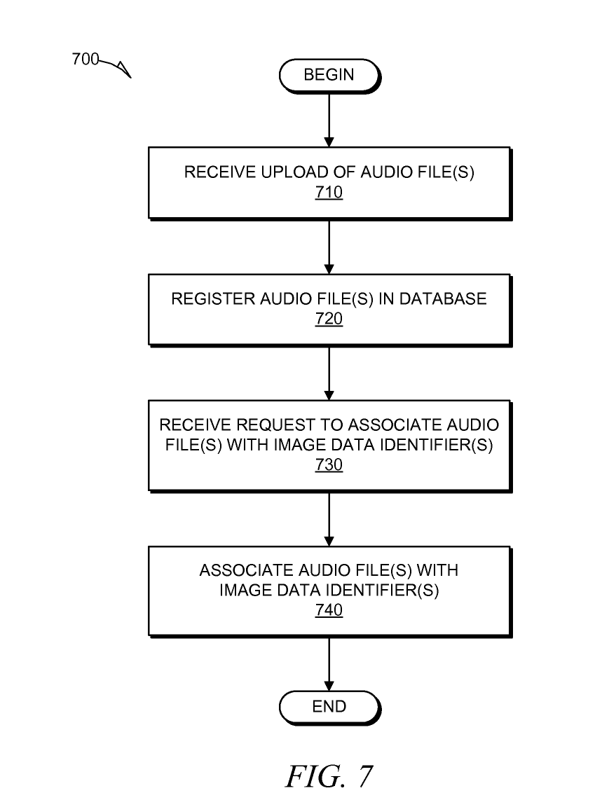

FIG. 7 is a flowchart illustrating a method 700 of managing audio files and image data identifiers for providing audio based on captured image data of visual content, in accordance with some embodiments. The operations of method 700 may be performed by a system or modules of a system (e.g., audio determination system 100 or audio management module 104 in FIG. 1). At operation 710, an upload of one or more audio files may be received. At operation 720, the one or more audio files may be registered in the database 106. At operation 730, a request to associate the audio file(s) with at least one corresponding image data identifier is received. At operation 740, the one or more audio files are associated, in the database 106 of audio files, with the corresponding image data identifier(s). It is contemplated that the operations of method 700 may incorporate any of the other features disclosed herein.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 214 of FIG. 2) and via one or more appropriate interfaces (e.g., APIs).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

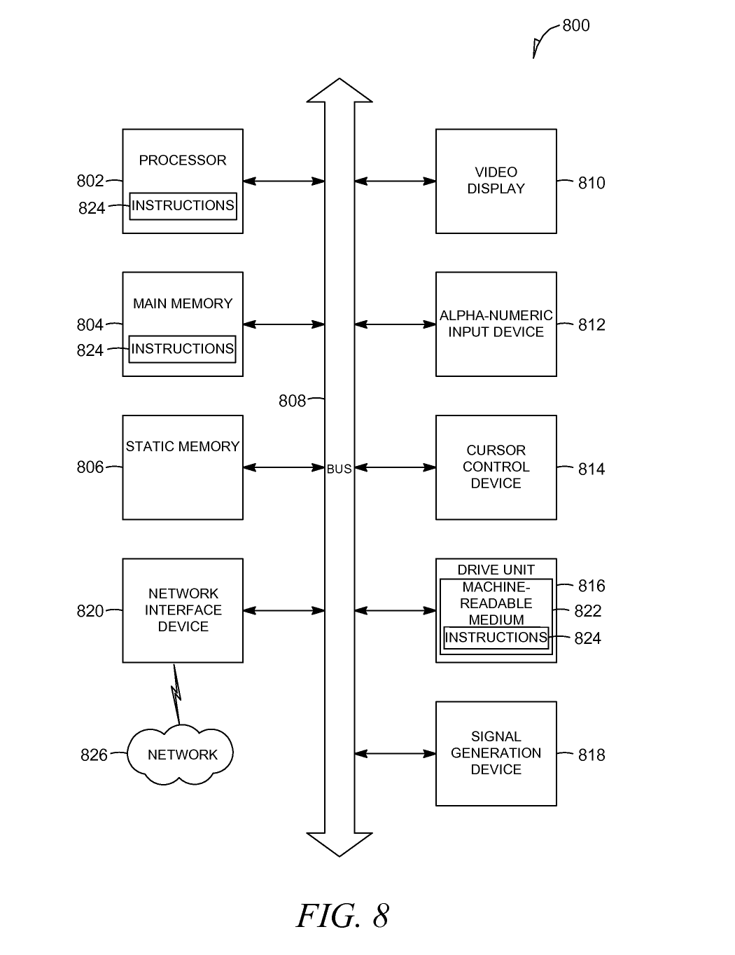

FIG. 8 is a block diagram of a machine in the example form of a computer system 800 within which instructions 824 for causing the machine to perform any one or more of the methodologies discussed herein may be executed, in accordance with an example embodiment. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard), a user interface (UI) navigation (or cursor control) device 814 (e.g., a mouse), a disk drive unit 816, a signal generation device 818 (e.g., a speaker) and a network interface device 820.

The disk drive unit 816 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804 and/or within the processor 802 during execution thereof by the computer system 800, the main memory 804 and the processor 802 also constituting machine-readable media. The instructions 824 may also reside, completely or at least partially, within the static memory 806.

While the machine-readable medium 822 is shown in an example embodiment to be a single medium, the term “machine-readable medium” may include a single medium or multiple media (e.g., a centralized or distributed database, and/or associated caches and servers) that store the one or more instructions 824 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

The instructions 824 may further be transmitted or received over a communications network 826 using a transmission medium. The instructions 824 may be transmitted using the network interface device 820 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

### Example Mobile Device

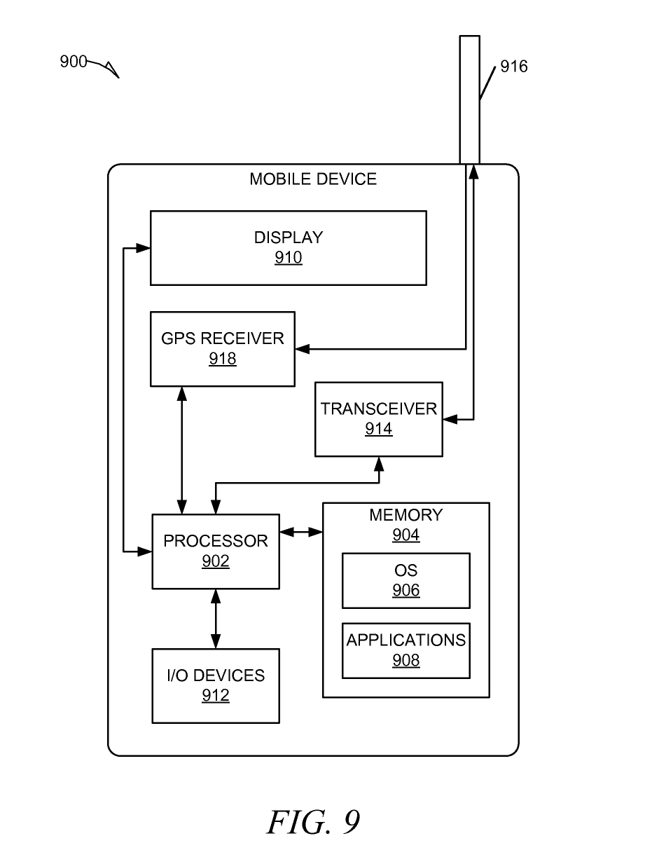

FIG. 9 is a block diagram illustrating a mobile device 900, according to an example embodiment. The mobile device 900 may include a processor 902. The processor 902 may be any of a variety of different types of commercially available processors 902 suitable for mobile devices 900 (for example, an XScale architecture microprocessor, a microprocessor without interlocked pipeline stages (MIPS) architecture processor, or another type of processor 902). A memory 904, such as a random access memory (RAM), a flash memory, or other type of memory, is typically accessible to the processor 902. The memory 904 may be adapted to store an operating system (OS) 906, as well as application programs 908, such as a mobile location enabled application that may provide LBSs to a user 102. The processor 902 may be coupled, either directly or via appropriate intermediary hardware, to a display 910 and to one or more input/output (I/O) devices 912, such as a keypad, a touch panel sensor, a microphone, and the like. Similarly, in some embodiments, the processor 902 may be coupled to a transceiver 914 that interfaces with an antenna 916. The transceiver 914 may be configured to both transmit and receive cellular network signals, wireless data signals, or other types of signals via the antenna 916, depending on the nature of the mobile device 900. Further, in some configurations, a GPS receiver 918 may also make use of the antenna 916 to receive GPS signals.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer-implemented method comprising:
receiving image data of visual content, the image data having been captured by a user computing device;
determining, by a machine having a memory and at least one processor, audio data based on the received image data; and
causing audio of the audio data to be played on the user computing device.

2. The method of claim 1, wherein determining the audio data comprises:
identifying the received image data based on at least one characteristic of the received image data; and
determining the audio data based on the identification of the received image data.

3. The method of claim 2, wherein identifying the received image data comprises using at least one computer vision technique to analyze the received image data.

4. The method of claim 2, wherein the reference image data comprises at least one of images and image identification rules.

5. The method of claim 1, wherein determining the audio data based on the received image data comprises:
accessing a database of audio files, each audio file registered in association with at least one corresponding image data identifier;
retrieving at least one of the audio files based on a correlation between the received image data and the at least one corresponding image identifier of the at least one audio file; and
providing the at least one audio file as the audio data to be played on the user computing device.

6. The method of claim 5, wherein the at least one registered audio file comprises a playlist of songs.

7. The method of claim 5, further comprising:
receiving, prior to receiving the image data of visual content, a request to associate the at least one audio file with the at least one corresponding image data identifier; and
associating, in the database of audio files, the at least one audio file with the at least one corresponding image data identifier in response to receiving the request.

8. The method of claim 7, wherein the request is received from a curator computing device different from the user computing device.

9. The method of claim 7, further comprising:
receiving, prior to receiving the request to associate, an upload of the at least one audio file; and
registering the at least one audio file in the database in response to receiving the upload of the at least one audio file.

10. The method of claim 1, wherein the received image data comprises video or still pictures.

11. The method of claim 1, wherein the audio of the audio data comprises a song or a voice recording.

12. The method of claim 1, wherein the user computing device comprises one of a smart phone, a tablet computer, a wearable computing device, a vehicle computing device, a laptop computer, and a desktop computer.

13. The method of claim 1, wherein the machine comprises a remote server separate from the user computing device.

14. A system comprising:
a machine having a memory and at least one processor; and
an audio determination module on the machine, the audio determination module being configured to:
receive image data of visual content, the image data having been captured by a user computing device;
determine audio data based on the received image data; and
cause audio of the audio data to be played on the user computing device.

15. The system of claim 14, wherein the audio determination module is further configured to:
identify the received image data based on at least one characteristic of the received image data; and
determine the audio data based on the identification of the received image data.

16. The system of claim 14, wherein the audio determination module is further configured to:
access a database of audio files, each audio file registered in association with at least one corresponding image data identifier;
retrieve at least one of the audio files based on a correlation between the received image data and the at least one corresponding image identifier of the at least one audio file; and
provide the at least one audio file as the audio data to be played on the user computing device.

17. The system of claim 16, further comprising an audio management module configured to:
receive a request to associate the at least one audio file with the at least one corresponding image data identifier; and
associate, in the database of audio files, the at least one audio file with the at least one corresponding image data identifier in response to receiving the request.

18. The system of claim 17, wherein the audio management module is further configured to:
receive an upload of the at least one audio file; and
register the at least one audio file in the database in response to receiving the upload of the at least one audio file.

19. The system of claim 14, wherein the audio determination module resides on a remote server separate from the user computing device.

20. A non-transitory machine-readable storage device, tangibly embodying a set of instructions that, when executed by at least one processor, causes the at least one processor to perform a set of operations comprising:
receiving image data of visual content, the image data having been captured by a user computing device;
determining, by a machine having a memory and at least one processor, audio data based on the received image data; and
causing audio of the audio data to be played on the user computing device.
